(19) United States
(12) Patent Application Publication
(10) Pub. No.: US 2005/0183524 A1
(43) Pub. Date: Aug. 25, 2005

(54) Centrifugal force generator

(76) Inventor: Luke Governo, Tiverton, RI (US)

Correspondence Address: Luke Governo, 867 Lake Rd., Tiverton, RI, 02878, US

(21) Appl. No.: 10/784,522

(22) Filed: Feb. 24, 2004

(51) Int. Cl. F16H 33/20

(52) U.S. Cl. 74/84 S

(57) ABSTRACT

The Invention has a main wheel, 2 outer wheels on opposite sides of each other. As the gears are connected directly in such a way which would allow the main wheel to spin but the 2 outer wheels always point in one direction. The outer wheels on identical points and as the main wheel spins the weights always point in one direction. As the wheel spins faster the force increases. Because the main wheel and outer wheels always point in one direction the main wheel would always be imbalanced in that direction, the faster the wheel turns the more centrifugal force on the one direction the weights are pointing, thus creating the force.

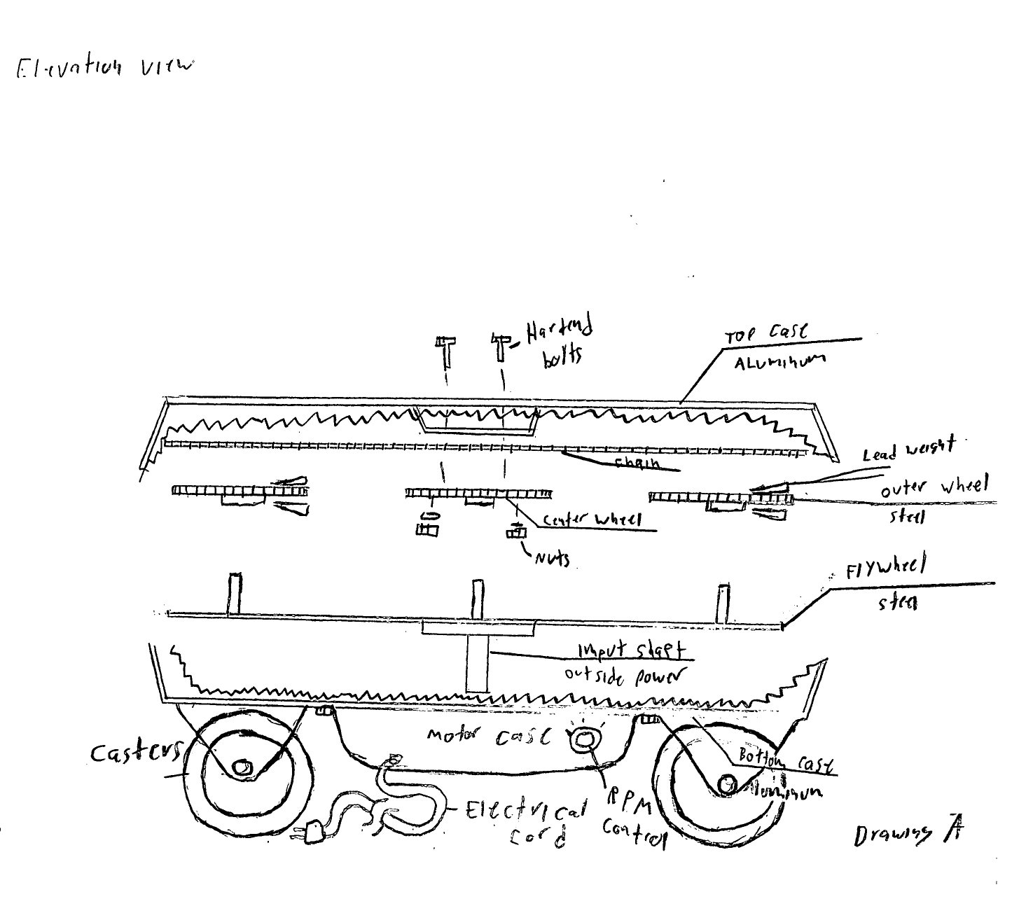

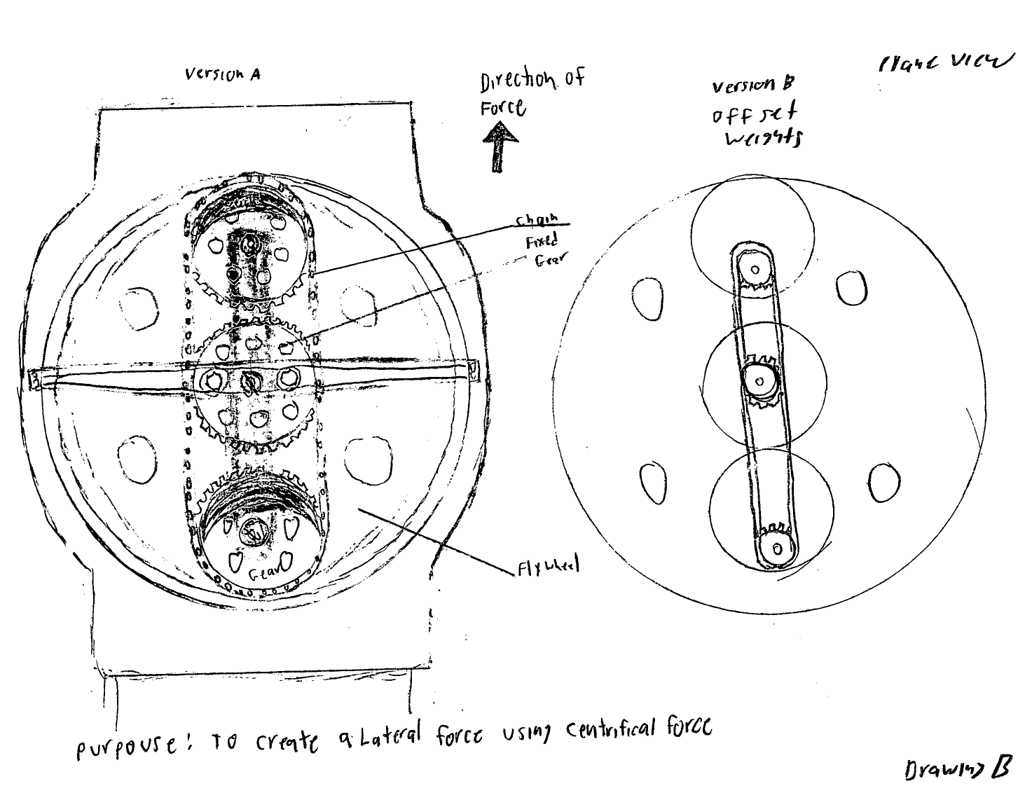

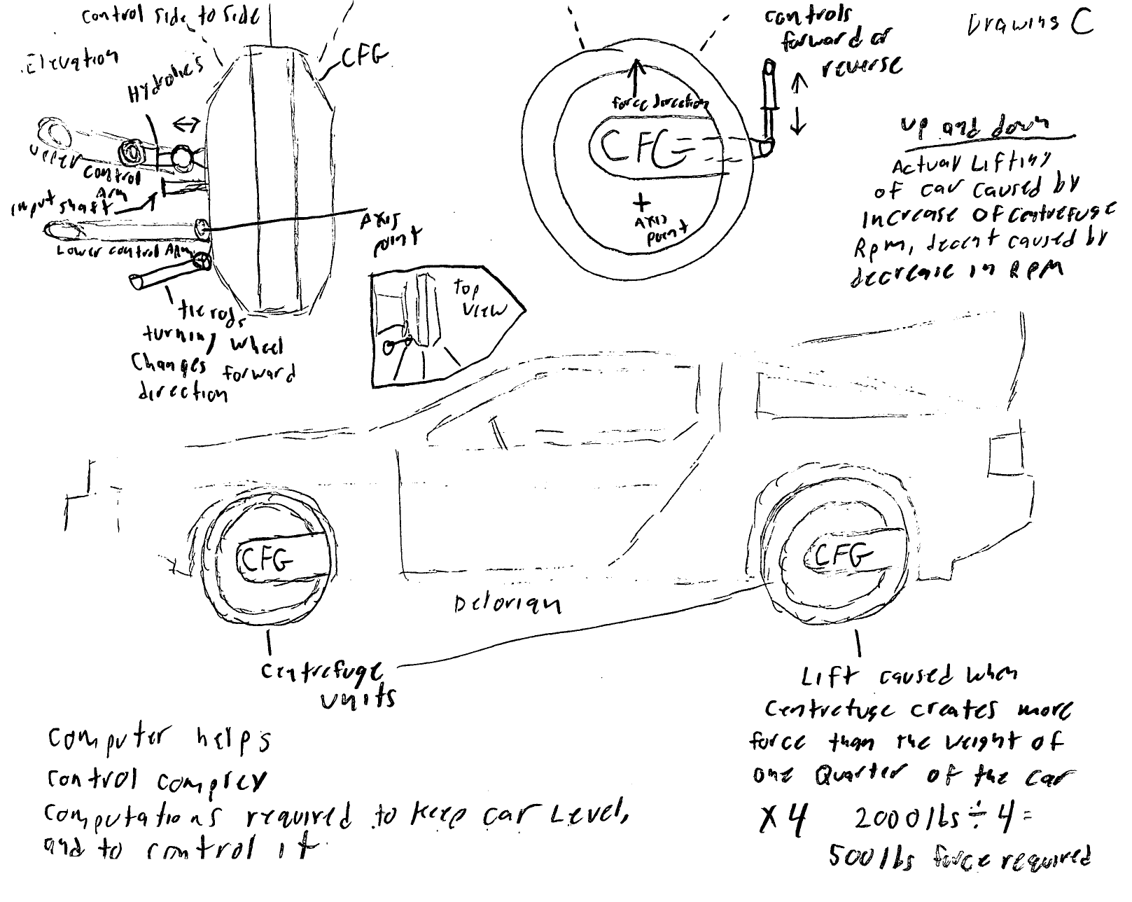

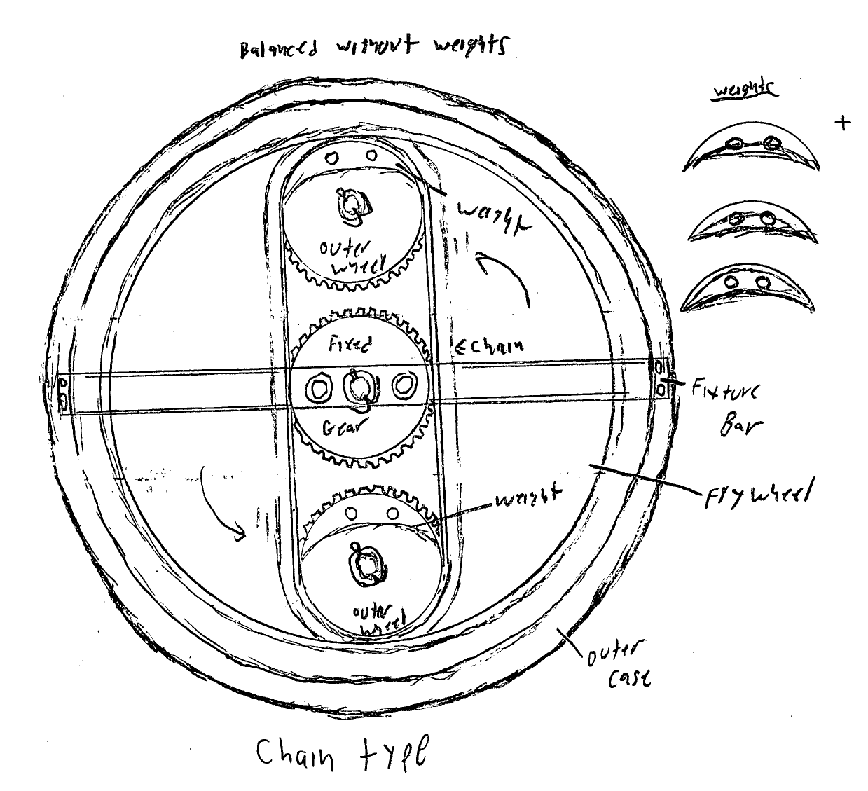

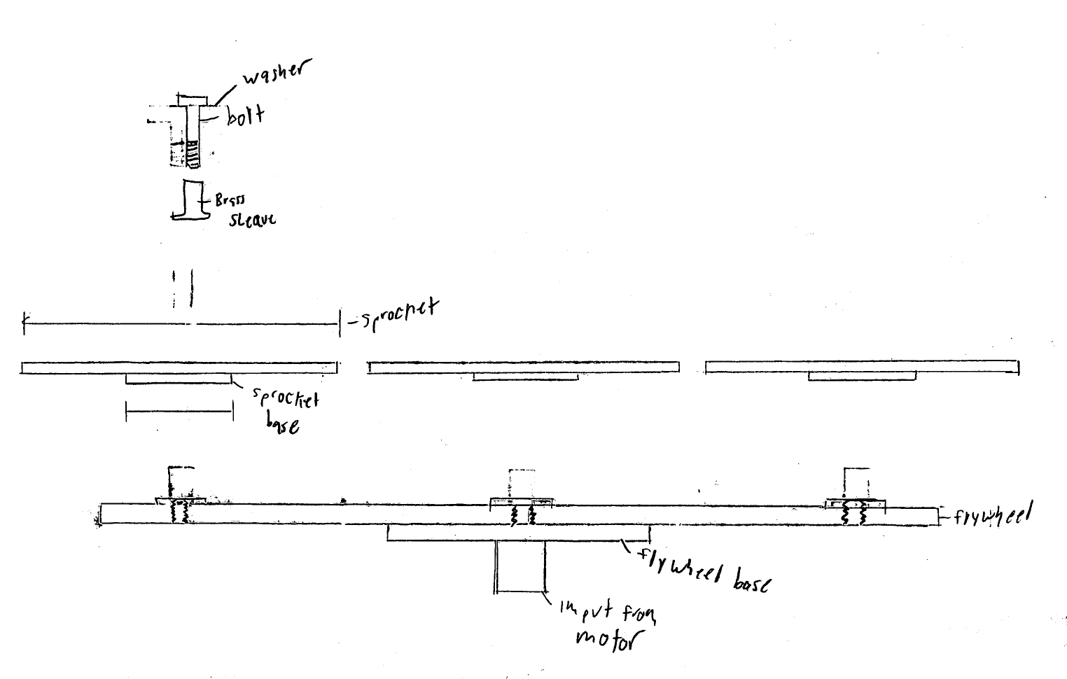

It consists of one main wheel, light weight, but strong. Two outer wheels with weights. Also an outer casing around the rotating mass, and gears to force the outer wheels as the main wheel terms around to always point in one direction.

### DESCRIPTION

The centrifugal force generator is a machine that harnesses centrifugal force and creates a lateral force, by using a large flywheel, then adding 3 smaller wheels, all equal size, one in the center, two on the outside opposite from each other, the outside one would have weights on one side, both outside wheels would have their weights pointing in the same direction, they would all be connected by a strong chain, the weights would be crescent shaped, to minimize vibration, the wheel will be fixed toan outer case so that when the flywheel turns, the outer wheels will move orbit ally, and the weights on those wheels will always point in the one direction in witch you want the force to go, as the flywheel speeds up, the imbalance will create a lateral force, the better the machine is made, the faster it can spin, the faster it spins, the more lateral force is created.

The centrifugal force generator would be a technological breakthrough, by being able to harness centrifugal force, people can use this to fly in planes more safely, the dream of flying cars can be economically realized, instead of helicopters, there could be centrificopters, NASA could use this to get ships into space easier, the air force could use it, The possibilities are endless.

1. A centrifugal force generator. The purpose of this device is to create an imbalance of force in one direction to move an object, using centrifugal force.
